(19) United States
(12) Patent Application Publication
(10) Pub. No.: US 2010/0208955 A1
(43) Pub. Date: Aug. 19, 2010

(54) METHOD AND DEVICE FOR AUTOMATICALLY ANALYZING BIOLOGICAL SAMPLES

(76) Inventors: Gabor Méhes, Graz (AT); Wolfgang Schmidt, Graz (AT); Christopher Wrighton, Lassnitzhohe (AT); Kurt Zatloukal, Graz (AT); Harald Zobl, Wundschuh (AT); Peter Hecht, Graz (AT)

Correspondence Address: HAHN & VOIGHT PLLC, 1012 14TH STREET, NW, SUITE 620, WASHINGTON, DC, 20005, US

(21) Appl. No.: 12/095,596

(22) PCT Filed: Nov. 29, 2006
(86) PCT No.: PCT/AT06/00493

§ 371 Date: May 7, 2010

(30) Foreign Application Priority Data
Nov. 30, 2005 (AT) A1933/2005

(51) Int. Cl. G06K 9/00

(52) U.S. Cl. 382/128

(57) ABSTRACT

The invention relates to a method for automatic analysis of biological samples, in particular tissue samples, comprising a device (11) for scanning the samples (1) for forming data sets (4) of the samples (1). To produce a method or a device (10) by which the regions of interest (ROI) of the sample (1) can be determined as quickly as possible and as much as possible without destroying the samples (1), at least one parameter (P) is selected without destroying the sample (1) from a data set (4) of the sample (1) that is formed by using autofluorescence, and this parameter or a value derived therefrom or a combination of parameters (P) or values derived therefrom is compared to at least one threshold value (S), and the comparison value is used as a criterion for determining regions of interest (ROI) of the sample (1) and stored together with a unique identification (ID) of the sample (1).

The invention relates to a method for automatic analysis of biological samples, in particular tissue samples, whereby the sample is stimulated with light and as a data set of the sample an image of the resulting fluorescence radiation of the sample is recorded and stored.

In addition, the invention relates to a device for automatic analysis of biological samples, in particular tissue samples, comprising a device, formed by at least one light source and a camera or a detector, for scanning the samples to form data sets of samples.

For purposes of diagnosis and research, it is common in medicine to collect various samples, for example tissue samples, and to subject them to various tests. In the case of tissue samples that were removed from human or animal organisms, it is common to embed individual large tissue pieces in paraffin that are worked up for further analysis transferred into thin-section preparations on glass supports. In addition, paraffin blocks can contain several small pieces of tissue. From other paraffin blocks, cylindrical cores (so-called cores) of tissue samples can be extracted from specific selected sites and introduced into correspondingly large cylindrical holes of a paraffin block. Such tissue sample arrays (tissue microarrays, TMAs) are then usually cut with the help of a microtome, and the preparations are studied, for example histologically.

To obtain important information as quickly as possible, in particular for diagnostic or therapeutic purposes, the above-described section preparations or tissue sample arrays due to the large number of sections and individual samples are supplied to enhanced automatic analyses. The studies can be performed with a microscope but also on a molecular level, whereby the exact contents and the composition of the initial material are of great importance. To facilitate the comparison and to reduce the material selection to what is relevant, the above-mentioned tissue sample arrays (TMAs) are produced. For example, US 2003/0215936 A1 describes a method and a device for the study of such tissue sample arrays that is as quick and efficient as possible.

Although in the subsequent description, primarily tissue samples are considered, the present invention is not limited to such samples. In addition to human, animal and plant tissues, combinations of the most varied tissues with different origins are suitable for use in this invention. Also, material that was extracted from tissue, such as, e.g. proteins and nucleic acids, which are applied drop by drop to a glass support, are examined with this invention. In addition, bodily fluids such as blood, saliva, etc., from living organisms can be analyzed. Finally, cultured cells or portions thereof but also organic or inorganic materials can also be present as samples.

In a large number of samples, it is of special importance to be able to make an assessment on the relevance of individual samples in the preparation. On the one hand, this is of great importance for the reliability of the assessments, which are made after the sample is analyzed, in particular for diagnoses in the medical field. On the other hand, the preparations represent an enormous economic value, which can be increased if an assessment can be made on the relevance of individual samples in the preparation.

In addition to the assessment on the relevance of the samples, it is also important to be able to make an assessment on any areas of the sample that are advantageous for subsequent studies. For example, in the case of histological samples, only that area of the sample is important that relates to, for example, a specific organ, while the surrounding fatty tissue is irrelevant. To date, such areas or regions of interest (ROI) were determined under a microscope by suitable experts in a cumbersome manual manner.

In this case, samples used for study are usually colored histologically to be able to detect the regions of interest more easily. For subsequent studies, these samples are no longer available because of the coloring. In sequences of sections, for example histological tissues, therefore sections of the samples are colored only on a random-sample basis. These random-sample analyses yield no information, however, on the actual regions of interest of the samples, which can vary from section to section. This information would be enhanced specifically in an increase of the number of random samples, but then fewer samples would be available for subsequent studies. Moreover, the controls that are usually performed manually are very time-consuming and thus costly.

The use of autofluorescence, which is the resulting radiation of elements that are stimulated with light of a specific wavelength, is a suitable examination method, in which the sample is not destroyed. Most materials contain chemical structures that can be stimulated especially with light and emit more or less fluorescence radiation. The autofluorescence depicts an image of the composition of the material and can also be used to depict biological or biochemical processes. In the case of tissues, both cellular and extracellular components emit fluorescence radiation. For example, nicotinamidadenine-dinucleotide (NAD) or flavinadenine dinucleotide (FAD), which mainly are arranged in the mitochondria, are considered to be primarily emitters of fluorescence beams. The quantity and the composition of various substances result in specific autofluorescence patterns at a specific stimulation, by which the identification of the composition and functional differences of tissues is made possible through the detection of the fluorescence radiation. Autofluorescence is used both for in vivo and in vitro characterization of biological material. For example, because of the blood circulation, the red blood dye hemoglobin is essentially found throughout the human body. Hemoglobin is strongly fluorescent, by which a different autofluorescent pattern of the tissues results because of the variability of the amount of hemoglobin. To study the blood circulation, this can be measured in vivo by a spectroscopic method (Yoshinori, Horie et al., “Role of Nitric Oxide in Good Ischemia-Reperfusion-Induced Hepatic Microvascular Dysfunction,” American Physiological Society (1997): G1007-G1013). Also, in opthalmology, autofluorescence is used to study the retina (Anthony G. Robson et al., “Comparison of Fundus Autofluorescence with Photopic and Scotopic Fine-Matrix Mapping in Patients with Retinitis Pigmentosa and Normal Visual Acuity”; Investigative Opthalmology & Visual Science 45 (11) (2004): 4119-4125). While numerous applications of in vivo or in vitro spectroscopy of autofluorescence exist, the autofluorescence still could not be established for the study of microscopic sections. By contrast, the fluorescence radiation of tissues in fluorescence microscopy was described as disadvantageous (Werner, Baschong et al., “Control of Autofluorescence of Archival Formaldehyde-fixed, Paraffin-embedded Tissue in Confocal Laser Scanning Microscopy (CLSM)”; The Journal of Histochemistry & Cytochemistry 49 (12) (2001): 1565-1571). The use of autofluorescence spectroscopy for studying microscopic structures was described only very rarely (Luigi Rigacci et al., “Multispectral Imaging Autofluorescence Microscopy for the Analysis of Lymph-Node Tissues,” Photochemistry and Photobiology 71 (6) (2000): 737-742); Erin M. Gill et al., “Relationship Between Collagen Autofluorescence of the Human Cervix and Menopausal Status,” Photochemistry and Photobiology 77 (6) (2003): 653-658).

The object of the present invention therefore consists in the production of an above-mentioned method for automatic analysis of biological samples, which method can be performed as quickly as possible and as much as possible without destroying the samples, and which yields results that are as reliable as possible with regard to the regions of interest of the sample or the informative nature of the samples. The method is to supply information on the regions of interest of the samples with the smallest possible costs in the shortest possible time. The drawbacks of the prior art are to be avoided or at least reduced.

Another object of the present invention consists in the production of an above-mentioned device for automatic analysis of biological samples, which allows as quick and reliable an analysis as possible and, moreover, is designed as simply and sturdily as possible, and can be produced as economically as possible.

The first object according to the invention is achieved in that the sample is scanned in a non-destructive manner and in that at least one parameter is selected from the stored data set of the sample, and this parameter or a value derived therefrom or a combination of parameters or values derived therefrom is compared to at least one threshold value, and the comparison value is used as a criterion for determining the regions of interest of the sample and is stored together with a unique identification of the sample.

The method according to the invention thus calls for certain parameters to be selected from a data set of the sample, which was formed and stored with making use of the fluorescence radiation by non-destructive scanning of the sample, and the regions of interest of the sample to be automatically determined therefrom and to be stored together with a unique identification of the sample. Here, the determination of the regions of interest must not be performed in a single process step, but rather the latter can also be determined iteratively in a closed loop. This iterative determination is based on a learning method from information that was obtained by manual examinations of biological samples or randomly selected, already preclassified samples. The selection of the at least one parameter can be carried out from empirical values based on the sample. As a result of the method according to the invention, a data set exists that for each sample makes a proposal for the regions of interest. This data set is especially important for the selection of subsequent studies and supports, e.g. the histologists in the selection of corresponding samples. As a result, a classification of a number of samples in a relatively fast time can also be performed in an automated manner and can be offered as a proposal for additional processing. The method for analysis of the biological samples can be carried out directly before the performed study of the samples or else at an earlier time, and the resulting data together with additional information and a unique identification of the sample are stored in, for example, a database in such a way that they are available for subsequent studies. As an alternative to storing the data in a database, said data can also be archived in the so-called flat-file format. In principle, the information that is obtained can be archived in any storage medium. A database structures and optimizes the process, however, primarily with respect to classification and documentation. By the method according to the invention, important information for diagnostic, therapeutic purposes but also for research purposes can be obtained. By means of the information that is obtained, the biological samples can be assigned to certain classes based on a heuristic. This method uses the autofluorescence for the non-destructive microscopic characterization of samples, in particular tissue samples. The pattern of the resulting fluorescence radiation of the sample makes possible an automatic analysis or decision on which parts of the sample are relevant for certain studies and which parts of the sample are irrelevant for certain studies. Thus, the autofluorescence can be used in addition to automatically distinguish the samples, for example the tissue or tissue parts, from the surrounding material, for example paraffin, or to point out specific tissue parts with functional differences from other tissue parts. Thus, the autofluorescence makes possible the automatic determination of components of the sample, in particular tissue components, without the sample being destroyed or further reactions occurring. A combination of the non-destructive method according to the invention with other methods in which the samples or parts thereof are impaired or even destroyed is also possible, of course, in order to obtain important additional information as a result.

Preferably, the fluorescence radiation is generated by stimulation of the sample with laser light. In addition to laser light, however, mercury lamps or other light sources that can induce autofluorescence can also be used.

According to another feature of the invention, the image of the resulting fluorescence radiation of the sample can be filtered. The recorded data sets or images of the samples can be filtered according to various criteria. Here, both mechanical filters, which are placed in front of the camera, etc., to record the images, and electronic filters, through which the image data pass, are used. In the case of a fluorescence microscope, for example, ultraviolet lamps and three different filters, for example with the following characteristics, are used.

| | Wavelength of | Transmission range |
|---|---|---|
| Filter | the exciter light | of the filter |
| Ultraviolet | 390 nm | 410 to 420 nm |
| Blue | 410 nm | 505 to 520 nm |
| Green | 515 nm | 560 to 610 nm |

In the case of fluorescence scanners, for example, lasers with two different wavelengths together with highly-specific fluorescence dyes, such as, e.g. CY3 (indocarbocyanine) or CY5 (indodicarbocyanine), are used. CY3 can, for example, be stimulated at 530 nm and emits light at a wavelength of 595 nm. CY5 is stimulated at 630 nm and emits fluorescence radiation at 680 nm.

Better results can also be achieved in that the sample is stimulated with combined light of different wavelengths. With such “multispectral imaging” different light sources are used and thus more information is obtained. As light sources, for example, lasers such as argon ions or helium/neon lasers are available. Moreover, instead of lasers, light sources with a wide wavelength range can be used. For example, mercury lamps or fiber-optic devices can be used as light sources.

To facilitate the subsequent processing of data sets, the latter are preferably stored in a standardized format, for example in TIFF or JPG format. This also makes possible the application of existing image processing programs and does not require any conversion of data sets before the study.

Advantageously, the data set of the sample is transformed into at least one binary data set. A binary data set consists of a matrix of logical zeros and logical ones, which can be analyzed accordingly. Such binary data sets are produced in such a way that specific parameters are compared to a threshold value or several threshold values. If more than one parameter is used, several binary data sets can accumulate that can be combined at a later time in an algorithm, for example by superposition and/or weighting. In principle, any image can be depicted by several binary images. For example, a color picture with 8-bit resolution, i.e. 256 possible color gradations, can be clearly depicted by superposition of 256 binary images.

As the parameter selected from the data set and used for analysis of the regions of interest of the samples, a fluorescence parameter, in particular the fluorescence intensity, can be used. The data are compared to a preset threshold value and then the comparison value is used as a criterion for determining the regions of interest of the sample. The respective threshold value can result from empirical values or can also be determined automatically by means of standardized statistical methods, for example the so-called box-plot method. This box-plot method uses the information of the accumulations of random samples as well as quantile information and makes possible a simple determination of a threshold value without requiring additional knowledge, for example on the biological sample. When using the fluorescence intensity as a parameter, the values are preferably put in a ratio with the intensity of the surrounding pixel, and a distribution of the fluorescence intensity is produced via the pixels of the image. As derived values of the parameter, for example, the variability in the fluorescence intensity, etc., can be used. The fluorescence intensity depends greatly on the distribution of each molecule that emits the fluorescence radiation and can therefore be used for the following automatic analyses:
1. Micromolecular range (homogeneity): small molecules in the cell (e.g. NAD, FAD, tryptophan, etc.) emit submicroscopic fluorescence, whose total quantity results in an indistinct intracellular picture. The fluorescence radiation is homogeneous if no disruptions by other fluorescence sources occur.
2. Macromolecular range (granularity): molecular complexes (e.g. porphyrins, lipopigments, coagulated proteins, etc.) exhibit a strong, granular fluorescence pattern that can be observed in a microscope or digital image. This can occur both in intracellular and extracellular molecules, which result in a variability of autofluorescence intensity.
3. Tissue composition (orientation): larger structures with specific molecular composition result in characteristic orientation of autofluorescence, as is the case in, for example, collagen-rich connective tissue with longitudinally-oriented parallel structures (fibers). As a result, it is possible to determine automatically the outlines of specific structures within the sample and thus to identify regions of interest (ROI).

At least one threshold value can be derived from at least one parameter. For example, the threshold value can be determined by means of the median when suitable parameters can be found, so that their distribution behaves in a stable manner; in the example of the median, i.e. a stable, unimodal distribution thus remains in the parameters.

The threshold value can also be correspondingly selected based on the type of sample. For example, information on the composition of the sample and corresponding threshold values determined from experience or other methods can be filed together with the sample. For example, weight can be assigned from specific information in a database also by means of a binary image, which was determined from, e.g. a gradient method.

The threshold values can also be altered based on the comparison values. Thus, the method according to the invention can be enhanced iteratively or by an adaptive algorithm.

The threshold value can also be influenced by outside parameters that are determined, for example, by experts.

According to another feature of the invention, it is provided that any regions of the samples whose comparison value is positive are characterized as regions of interest. This represents a simple method that distinguishes regions of interest from areas of non-interest.

Advantageously, the geometric shape of the regions of interest of the sample is determined and stored for further processing and analysis. The geometric shape can be classified by, for example, superpositions with preset geometric bodies or by storing characteristics, such as, e.g. center of gravity, maximum and minimum expansion, main expansion direction, etc. Thus, they can be shown later and used for subsequent studies.

In the data set of the sample, the areas of the sample that lie outside of the regions of interest can be erased or otherwise selectively depicted. As a result, studies of parts of the sample that are not of interest are prevented from being performed.

The areas of the sample that lie outside the regions of interest can also be cut out, whereby in particular lasers can be used for cutting.

To be able to make an assessment on the quality of the sample, the sizes of the regions of interest of the sample can be determined. Moreover, based on the resulting sizes, the decision for subsequent studies can be facilitated.

In this case, the ratio of the sizes of the regions of interest to the total surface area of the sample can be formed and stored together with the unique identification of the sample. This ratio provides information on how large the proportion of the regions of interest of the sample is.

Ultimately, in the automatic method, it can be provided that any samples whose ratio of the sizes of the regions of interest to the total surface area of the sample fall below a preset boundary value are characterized as unusable. As a result, an elimination of samples that have too small a proportion of regions of interest can automatically be performed.

For automatic analysis, additional data sets that originate from other sources can be used. At least one additional parameter for determining the regions of interest can be selected from these data sets. Such an additional data set can be, for example, a possibly colored microscopic image of the sample that contains additional advantageous information. The automatic analysis of the sample can be further enhanced by the superposition of the microscopic data set with the data set resulting from, for example, fluorescence radiation.

To be able to perform the analysis as quickly as possible, preferably several samples are processed automatically sequentially or in parallel, and the data obtained for the regions of interest of the samples are stored together with an identification of the samples. Thus, as early as after the production of the samples, data on the regions of interest of the samples can be collected and stored. These data are then available for a selection of the samples for specific subsequent studies.

The second object according to the invention is also achieved by an above-mentioned device for automatic analysis of biological samples, in particular tissue samples, and a device for scanning the samples for forming data sets of samples is provided, whereby the scanning device that is designed for non-destructive scanning of the samples is connected to a computer unit for selecting at least one parameter from the data set and for comparing this parameter or a value derived therefrom or a combination of parameters or values derived therefrom with at least one threshold value, and also a device for display of a region of interest of the sample that is determined from the comparison value and a memory for storing this area together with a unique identification of the sample are provided. The recording device is formed by at least one light source and a camera or a detector. In the case of autofluorescence, a fluorescence scanner or a fluorescence microscope is used, which records as a data set the fluorescence radiation of the sample stimulated with a corresponding light source. A device for automatic analysis of biological samples according to this invention therefore usually consists of a computer unit, which is connected to a scanning device that is formed from at least one light source and a camera or a detector, and the information that is obtained is correspondingly processed.

The light source can be formed by, for example, a laser, an UV lamp or combinations thereof.

Several light sources can also be provided in various wavelength ranges or else a light source that emits light in a very broad wavelength range.

The scanning device contains, for example, a microscope and/or a scanner

In addition, a device for transforming the data set of the sample into at least one binary data set can be provided.

To increase the relevance of the data, a filter device can be provided for filtering the data sets of the samples. As already mentioned above, in this case these can be filters that are arranged in front of the recording device as hardware, but also filters that undertake a software adjustment of the data that is obtained.

In addition, a microscope can be provided to record samples for producing additional data sets.

To allow the fastest possible analysis, a device for automatic feed and exhaust of the samples can be provided.

Also, a magazine for receiving a plurality of samples can be provided, from which the samples are automatically removed for analysis and returned again. Thus, a fast automated analysis of the samples can be achieved.

In what follows, the present invention is explained in more detail based on the attached drawings, wherein

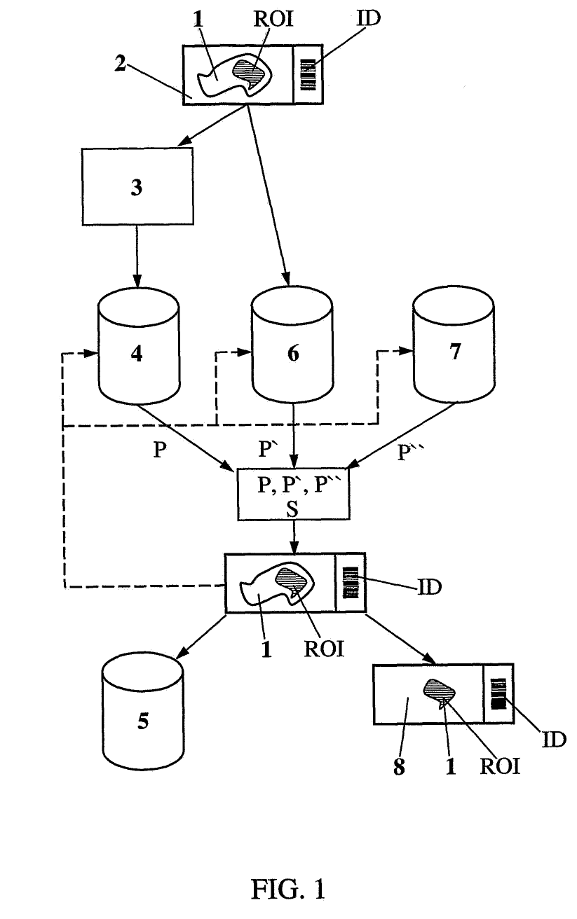

FIG. 1 shows a schematic block diagram for illustrating the method according to the invention;

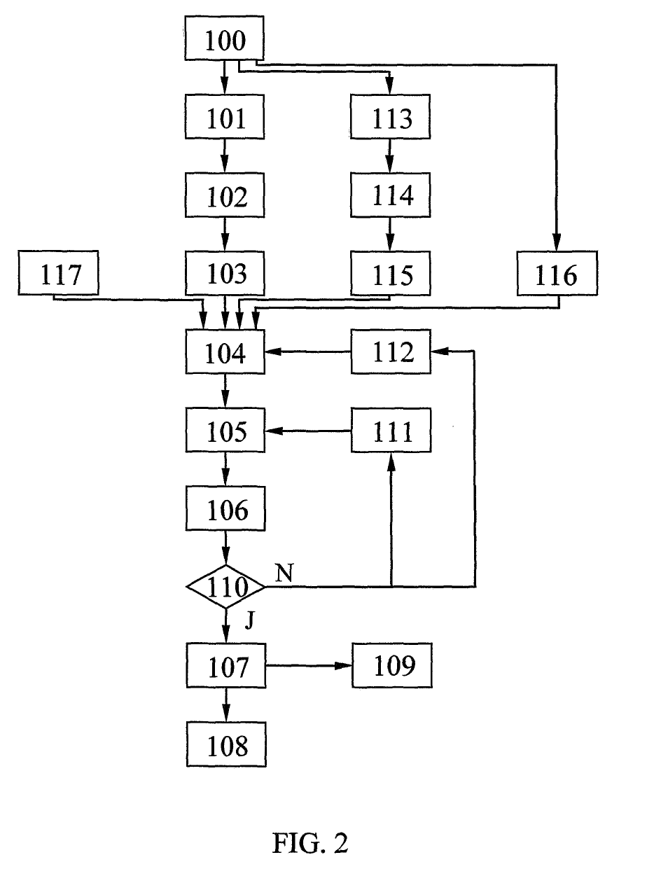

FIG. 2 shows a flow diagram for illustrating the method for automatic analysis of biological samples;

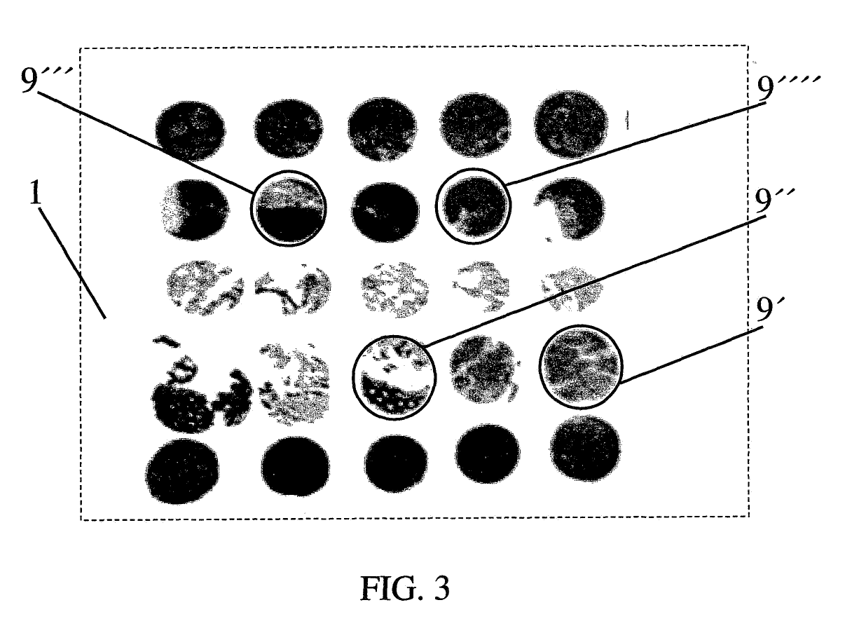

FIG. 3 shows the view of a tissue sample comprising several individual samples;

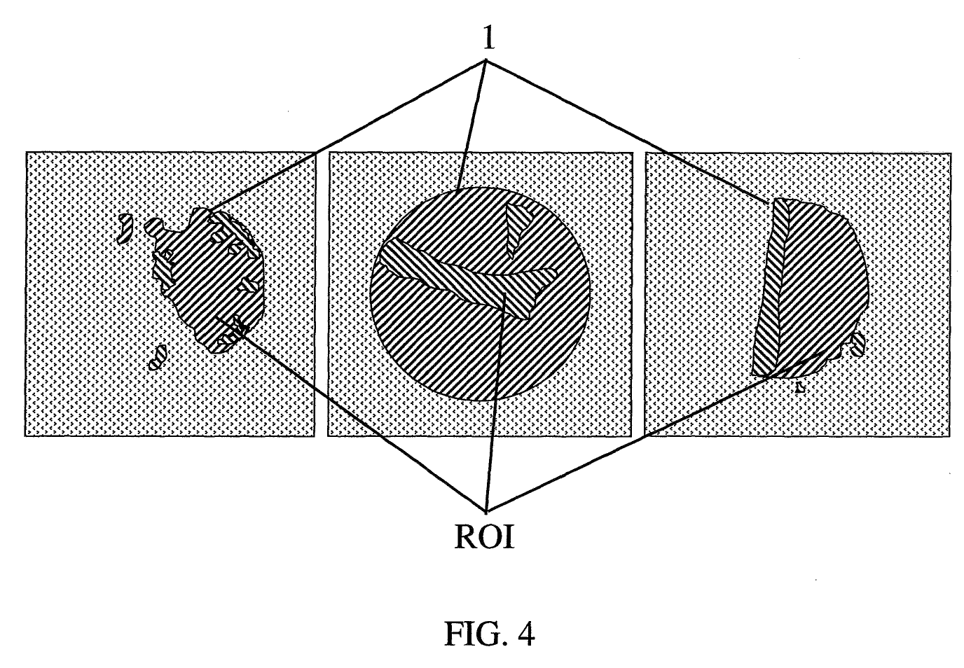

FIG. 4 shows various tissue samples, by way of example, with a different proportion of the regions of interest;

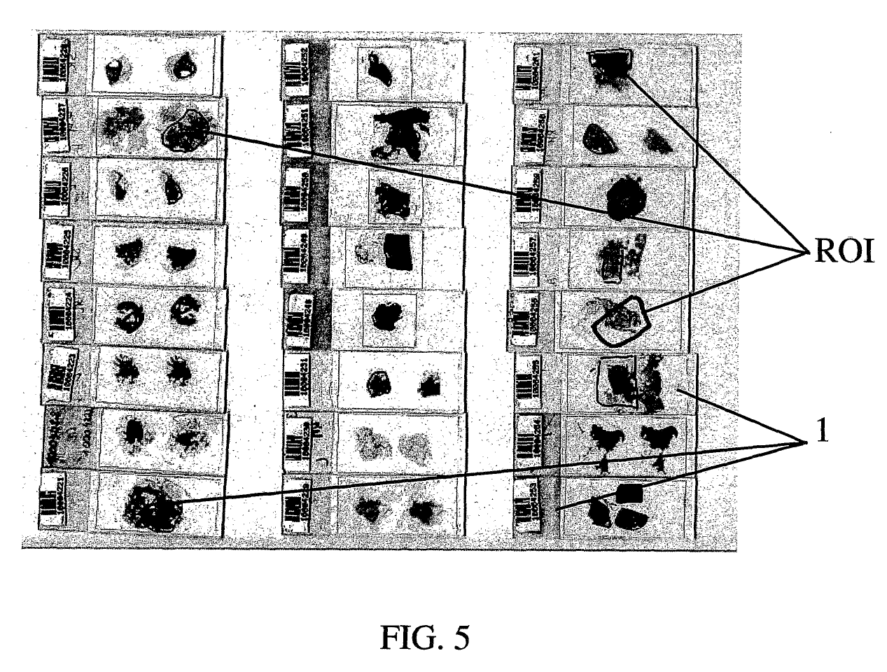

FIG. 5 shows the top view of different tissue samples; and

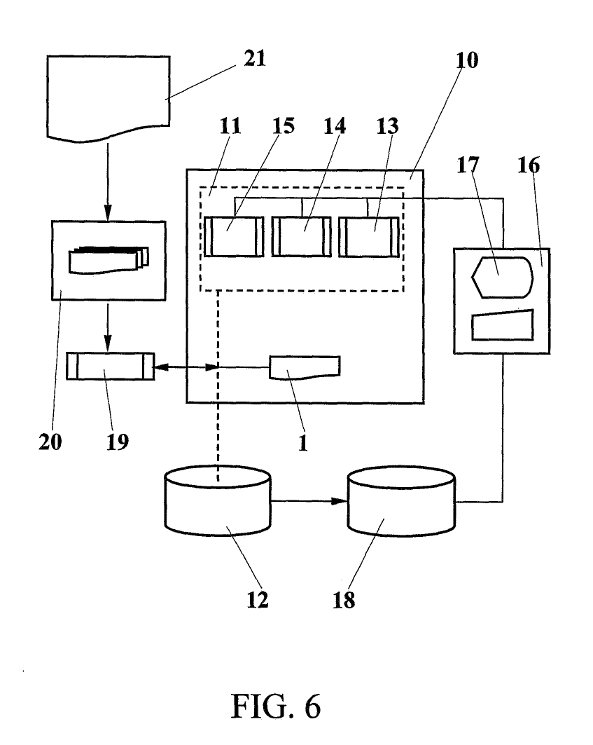

FIG. 6 shows a block diagram of an embodiment of the device for automatic analysis of biological samples.

FIG. 1 shows a schematic block diagram for illustrating the method for automatic analysis of biological samples 1. The biological sample 1 can be, for example, a section of an organ, etc., which was produced with the assistance of a microtome and is to be studied histologically. The sample 1 is applied in most cases to a glass support 2 and has a unique identification ID, for example, in the form of a bar code. In most cases, only a portion of the total area of the sample 1 contains useful information. For example, in most cases, any area in a tissue section that was removed from a specific organ, for example the liver, and not the surrounding fatty tissue or connective tissue, is of interest. Usually, the areas of interest, the so-called “regions of interest” (ROI), are fixed manually by appropriate specialists. Here, coloring methods can be used in a support role, by which, however, the sample 1 is influenced and for many subsequent studies is no longer available. For this purpose, one goal is to analyze the sample 1 automatically to be able to determine automatically the regions of interest ROI. As a result, an especially important piece of information for the subsequent studies on the sample 1 is made available. So as not to destroy the sample 1 or not to influence it, the latter is scanned in a non-destructive manner with corresponding devices 3, and at least one data set 4 of the sample 1 is produced. At least one parameter P is now selected from this data set 4, and this parameter or a value derived therefrom or a combination of parameters P or values derived therefrom is compared to at least one threshold value S, and the comparison value is used as a criterion for determining the regions of interest ROI of sample 1. By the determination of two threshold values S or a specific value for a threshold value S, an interval in which a parameter P must be detained to meet a specific classification can also be determined by the threshold value S. As a result of the corresponding calculation, i.e. a proposal for the region of interest ROI or the region of interest ROI of the sample 1 is set forth. Then, a data set 5 is formed, which contains the determined regions of interest ROI of the sample 1 together with the unique identification ID of the sample 1. This data set 5 together with the sample 1 forms an important unit, by which subsequent studies on the sample 1 can be performed more quickly and more efficiently. Also, the method according to the invention is used for automatic analysis of biological samples 1, which have no region of interest or too small a region of interest ROI, to identify each sample 1 more quickly. Thus, costly studies on unsuitable samples 1 may be omitted, and time can be saved for the manual classification of samples 1.

Additional data sets 6 can also be formed from the sample 1, from which further parameters P′ that are used for determining the regions of interest ROI can be selected. In such data sets 6, for example, these can be microscopic images of sample 1 but also data that are produced by, for example, specific coloring methods, etc., on the sample 1. Thus, important additional information that accelerates or enhances the automatic analysis of the sample 1 is produced.

In addition to such additional data sets 6, data sets 7 that were substantiated from the knowledge of experts can also be used. For example, specific hypotheses on various types of samples 1 in such data sets 7 that can be confirmed by previous studies can be collected. These data sets 7 can supply additional parameters P″ that can be used for calculating and determining the regions of interest ROI of the sample 1.

As illustrated in the figure by the broken lines, the determination of the regions of interest ROI of the sample 1 can also be carried out iteratively by the parameters of the data sets 4, 6, 7 being changed until an optimum result exists.

Ultimately, after receiving the result of the region of interest ROI of the sample 1, any area of sample 1 that lies outside said region of interest ROI can also be removed. A preparation 8, whose sample 1 exclusively consists of the automatically determined regions of interest ROI and the unique identification of sample 1, now results. It is thus prevented that complex and costly studies are performed on areas that are not of interest of sample 1.

FIG. 2 shows a flow diagram for further illustration of the method according to the invention for automatic analysis of biological samples 1. Starting from the sample 1 according to block 100, this corresponding block 101 is scanned in a non-destructive manner. The non-destructive scanning is carried out in this case by optical methods making use of autofluorescence radiation. After the sample 1 is scanned, a data set (block 102) is formed, which can still be filtered or transformed (block 103). According to block 104, at least one parameter P is selected from the data set, and a corresponding block 105 determines at least one threshold value S. According to block 106, at least one parameter P or a value derived therefrom or a combination of parameters P and values derived therefrom is compared to at least one threshold value S to determine the region of interest ROI or the regions of interest ROI of sample 1 (block 107) from the comparison value. The determined region of interest ROI is stored together with the identification ID of the sample 1 (block 108) and is in any case graphically depicted (block 109). Before the determination of the region of interest ROI corresponding to block 107, a query according to block 110 can be made as to whether the result readily appears based on specific criteria. If this is the case, the determined regions of interest ROI of the sample 1 corresponding to block 107 is determined. If this is not the case, however, at least one threshold value S according to block 111 can be altered and matched, and at least one parameter P according to block 112 can be altered and matched, and again the regions of interest (ROI) of the sample 1 can be determined. This loop is repeated often until the result corresponding to the query 110 is satisfactory and thus the region of interest ROI of the sample 1 according to block 107 is determined.

With the sample 100, additional analyses corresponding to block 113 can be performed, and corresponding data sets can be formed (block 114) and in any case preprocessed (block 115). The thus determined data can be used for selecting parameters according to block 104. Also, manual adjustments by experts corresponding to block 116 for the selection of parameters according to block 104 as well as data from knowledge databases (block 117) can be used, and the result of the automatic analysis of the biological method 1 is enhanced.

FIG. 3 shows the top view of an image of a sample 1 in the form of a tissue sample array (TMA) that consists of 25 individual samples 9. The sample 1 is a tissue section of a specific target tissue, for example liver. The individual sample 9′ has, for example, no target tissue or a reaction with a specific coloring of the tissue and therefore has no region of interest ROI. In the individual sample 9″, about 50% of the total surface is covered with target tissue or has a reaction. The individual sample 9′″ also has about 50% target tissue, which indicates a strong specific reaction. Finally, the individual sample 9″″ for the most part shows target tissue that, however, exhibits a specific reaction only weakly. The figure shows a diversity of different samples, which normally must be analyzed in time-consuming manual activity.

FIG. 4 shows three diagrammatic figures of autofluorescence images of various samples 1 with different compositions and thus different sizes of the regions of interest ROI. In this case, these are diagrammatic figures of actual measurement results.

Finally, FIG. 5 shows a few tissue samples 1, in which the manually determined regions of interest ROI were determined and identified. The regions of interest ROI are, for example, cancer tissue; conversely, the irrelevant areas outside of the regions of interest ROI are fatty tissue, connective tissue, etc.

Finally, FIG. 6 shows a block diagram of a possible device 10 for automatic analysis of biological samples 1. The device 10 has a unit 11 for non-destructive scanning of samples 1. The scanning unit 11 can be connected to a database 12 that contains information on the samples 1. The scanning unit 11 is formed by at least one light source 13, preferably a laser, and a device 14 for recording an image of the sample 1. For additional information, a microscope 15 can be arranged to record an image of the samples 1 to produce additional data sets. The scanning unit 11 is connected to a computer unit 16, which correspondingly processes the data of the scanned samples 1. In the computer unit 16, at least one parameter P is selected from the data sets of the sample 1 and this parameter P or a value derived therefrom or a combination of parameters P or values derived therefrom is compared to at least one threshold value S, and the comparison value is used as a criterion for determining regions of interest ROI of sample 1. These regions of interest ROI are shown in a display device 17, for example a screen, and are stored in a memory 18 together with the identification ID of the sample 1. For more efficient execution of the method, a device 19 for automatic feed and exhaust of the samples 1 can be provided, which preferably is connected to a magazine 20 for receiving a number of samples 1, which were removed form a corresponding stock 21.

1. A method for automatic analysis of biological samples (1), in particular tissue samples, whereby the sample (1) is stimulated with light, and as a data set (4) of the sample (1), an image of the resulting fluorescence radiation of the sample (1) is recorded and stored, characterized in that at least one parameter (P) is selected from the stored data set (4) of the sample (1) and this parameter or a value derived therefrom or a combination of parameters (P) or values derived therefrom is compared to at least one threshold value (5), and the comparison value (V) is used as a criterion for determining the regions of interest (ROI) of the sample (1) and is stored together with a unique identification (ID) of the sample (1), wherein the sample (1) is scanned in a non-destructive manner and therefore it remains suitable for subsequent examinations.

2. The method according to claim 1, wherein the sample (1) is stimulated with laser light.

3. The method according to claim 1, wherein the image of the resulting fluorescence radiation of the sample (1) is filtered.

4. The method according to claim 1, wherein the sample (1) is stimulated with combined light of different wavelengths.

5. The method according to claim 1, wherein the data set (4) of the sample (I) is stored in a standardized format, for example in TIFF or JPG format.

6. The method according to claim 1, wherein the data set (4) of the sample (1) is transformed into at least one binary data set.

7. The method according to claim 1, wherein as the parameter (P) a fluorescence parameter, in particular the fluorescence intensity, is used.

8. The method according to claim 1, wherein at least one threshold value (S) is derived from at least one parameter (P).

9. The method according to claim 1, wherein the threshold value (S) is selected based on the type of sample (1).

10. The method according to claim 1, wherein the threshold value (S) is altered based on the comparison value (V).

11. The method according to claim 1, wherein the threshold value (S) is influenced by an external parameter (P″).

12. The method according to claim 1, wherein any areas of the samples (1) whose comparison value is positive are characterized as regions of interest (ROI).

13. The method according to claim 1, wherein the geometric shape of the regions of interest (ROI) is determined and is stored for additional processing and analysis.

14. The method according to claim 1, wherein in the resulting data set (5) of the sample (1) the areas that lie outside the regions of interest (ROI) of the sample (1) are erased or otherwise selectively depicted.

15. The method according to claim 1, wherein the areas of the sample (1) that lie outside of the regions of interest (ROI) are cut out.

16. The method according to claim 1, wherein the sizes of the regions of interest (ROI) of a sample (1) are determined.

17. The method according to claim 16, wherein the ratio of the sizes of the regions of interest (ROI) to the total surface area of the sample (1) is formed and is stored together with the unique identification (ID) of the sample (1).

18. The method according to claim 17, wherein any samples (1) whose ratios of the sizes of the regions of interest (ROI) to the total surface area of the sample (1) fall short of a preset boundary value are characterized as unusable.

19. The method according to claim 1, wherein at least one parameter (P″, P′″) is selected based on at least one additional data set (6, 7) of the sample (1).

20. The method according to claim 1, wherein several samples (1) are processed automatically sequentially or in parallel, and the data obtained for the identified regions of interest (ROI) of the samples (1) are stored.

21. A device (10) for automatic analysis of biological samples (1), in particular tissue samples, comprising a device (11) that is formed by at least one light source (13) and a camera or a detector for scanning the samples (1) for forming data sets (4) of samples (1), characterized in that the scanning device (11) that is designed for non-destructive examination of the samples (1) is connected to a computer unit (16) for selecting at least one parameter (P) from the data set (4) and for comparing this parameter (P) or a value derived therefrom or a composition of parameter (P) or values derived therefrom to at least one threshold value (S); and that a device (17) for displaying a region of interest (ROI) determined from the comparison value of sample (1) and a memory (18) for storing this region (ROI) together with a unique identification (ID) of the sample (1) are provided.

22. The device according to claim 21, wherein at least one light source (13) is formed by a laser.

23. The device according to claim 21, wherein at least one light source (13) is formed by a UV lamp.

24. The device according to claim 21, wherein several light sources (13) are provided in various wavelength ranges.

25. The device according to claim 21, wherein the scanning device (11) contains a microscope.

26. The device according to claim 21, wherein the scanning device (11) contains a scanner.

27. The device according to claim 21, wherein a device for transforming the data set (4) of the sample (1) into at least one binary data set is provided.

28. The device according to claim 21, wherein a filter device for filtering the data sets (4) of the samples (1) is provided.

29. The device according to claim 21, wherein a microscope (15) for recording the samples (1) to produce additional data sets (6) is provided.

30. The device according to claim 21, wherein a device (19) for automatic feed and exhaust of the samples (1) is provided.

31. The device according to claim 21, wherein a magazine (20) for receiving a number of samples (1) is provided, from which the samples (1) are removed and returned again in an automated manner for analysis.

32. The method according to claim 7, wherein as fluorescence intensity the autofluorescence intensity of the sample (1) is used.
